(19) United States
(12) Patent Application Publication
(10) Pub. No.: US 2021/0023583 A1
(43) Pub. Date: Jan. 28, 2021

(54) HEAT SPREADER AND WAVE GUIDE UNIT, AND CONVEYOR-TYPE PAINT DRYING FURNACE COMPRISING SAME

(71) Applicants: So Ang CHO, Busan (KR); THREE TECH CO., LTD., Busan (KR)

(72) Inventors: So Ang CHO, Busan (KR); Kuk Rae CHO, Changwon-si (KR)

(21) Appl. No.: 16/962,839

(22) PCT Filed: Jan. 15, 2019
(86) PCT No.: PCT/KR2019/000574

§ 371 Date: Jul. 16, 2020

(30) Foreign Application Priority Data
Jan. 17, 2018 (KR) 10-2018-0005914

(51) Int. Cl. B05C 9/14; H05B 3/00; F27D 3/12; F26B 15/12; B05B 15/00

(52) U.S. Cl. CPC B05C 9/14; H05B 3/0038; F27D 3/12; F27D 2003/125; B05B 15/00; H05B 2203/032; F26B 15/12

(57) ABSTRACT

A heat spreader and waveguide (HSWG) unit of the present invention includes a main body having a ceiling portion and a wall wherein the ceiling portion and the wall are provided with waveguides, and one or more heat spreader modules in a space inside the main body, wherein at least one waveguide among a waveguide extending downward from one lower side of the heat spreader module and an intermediate waveguide extending downward in a curtain manner is further included, and each of the ceiling portion and the wall is formed in a unit length so that a plurality of units is combined to form a paint drying furnace. In the HSWG unit of the present invention, the heat spreader module includes a housing opened downward, and a radiant wave generator including a radiant wave converter 111a and a heater is provided in the housing, wherein the heater is provided in the radiant wave converter so that thermal energy from the heater is converted into radiant wave energy by a radiant wave conversion material applied to a surface of the radiant wave converter and then is emitted.

### FIELD OF INVENTION

The present invention relates to a heat spreader and waveguide (HSWG) unit, and a conveyor type paint drying furnace provided with the same. More particularly, the present invention relates to a conveyor type paint drying furnace equipped with HSWG units that can generate radiant waves by means of a high performance radiant generator and then emit the radiant waves to an object to be coated, which passes through the drying furnace in a conveyor mode, thereby drying a coated portion of the object quickly and uniformly.

### BACKGROUND OF INVENTION

As the industry becomes more advanced, importance of core material parts and product design is increasing. Especially, in the case of automobiles and home appliances in close contact with consumers, color design of the product is an important factor in stimulating consumer psychology (or exciting consumer curiosity). As a result, the product is frequently changed in color design and promoted through TV and internet (including smartphones) to increase consumer's desire for purchasing.

In addition, various kinds of paints for applying new and creative color designs to the exterior of products such as liquid coating, powder coating, electrodeposition, plating, etc. have been developed. Further, coating techniques have made dramatic progress from paint application using a brush and manual spray coating to robot painting through automatic machinery.

However, after the above-described painting operation, a coated surface of the product is not peeled off and durability is enhanced only by quickly drying the coated surface. Accordingly, the product is coated using paint such as liquid coating, powder coating, electrodeposition, plating, etc. and then dried in a heat drying furnace to dry the paint to be firmly adhered to the product. Such a conventional heat drying furnace entails many problems since it uses a hot-air drying furnace which adopts direct and indirect convection of hot air generated by flame of a burner to heat and dry the coated surface.

In other words, the conventional hot-air convection type heat drying furnace not only entails high coating failure rate, but also consumes a large amount of energy and greenhouse gas due to use of the flame of the burner. In addition, a fresh time is offered between steps in drying the painted product, hence causing such problems that a time required for drying is long, a length of the conveyor is long and a layout of painting equipment is enlarged. Further, in the case of composite coating wherein various coating methods are simultaneously applied, there is a problem that drying cannot be executed in a single drying furnace.

In addition, temperature deviation in the drying furnace is more than ±10° C., and color change occurs on the coated surface, thus causing a problem of coating failure.

On the other hand, as a result of investigation of prior art relating to the present invention, the following patent literature has been found.

Patent Literature 1 discloses a drying apparatus for automobile paint booths to provide optimum working conditions and convenience for realizing the same, wherein: a passage to supply hot air is formed in a tubular shape to minimize heat loss when hot air flows into the booth and to allow the hot air to more easily flow owing to the tubular configuration; a fuel saving type electric heater has improved configuration, instead of using a burner type heater with high fuel consumption, so as to more rapidly generate hot air and conserve energy; and an injecting angle of nozzles for spraying the hot air is easily adjustable. Patent Literature 2 discloses a system for drying a coated product, comprising: a hot air guiding duct which guides and outputs hot air from a hot blower side to an adjacent portion of an object to be coated (“object”) while being connected to a hot air supply duct; a curtain to provide a hot air effective area, which covers the periphery of the object while selectively ascending and descending according to an operational status of the hot blower, so as to limitedly define a series of hot air effective areas around the object; a far-infrared ray output device which is arranged above the object and outputs a series of far infrared rays according to the operational status of the hot blower so as to improve a drying speed of the object, wherein these components are arranged in a systematic manner, whereby optimum drying conditions to minimize heat loss of the hot blower and/or to maximize a drying rate and a drying speed of the object may be induced and stably realized. According to the above invention, such different problems annoying the manufacturer that heat loss at the hot blower side is greatly increased, a drying cost for the entire object is greatly increased, a drying time for the entire object is considerably delayed, production efficiency of the entire product (e.g., ship, vehicle, airplane, etc.) is considerably deteriorated, an operation rate of the entire coating process is greatly decreased, or the like, may be efficiently prevented.

Patent Literature 3 discloses a multipurpose painting booth with improved drying performance, comprising: a coating chamber provided with a ceiling filter and a bottom filter; an air supply device for supplying external air; an air exhausting device for exhausting air in the coating chamber; and an aqueous dryer for drying water-soluble paint, wherein an inner space of the coating chamber is connected with an external air inflow passage in the air supply device through a hot air recovery passage, and a damper is provided in each of the hot air recovery passage and the external air inflow passage wherein each damper is disposed at a suction side of an air supply fan provided in the external air inflow passage while arranging a suction duct of the aqueous dryer in a hot dry air inflow space. According to the simple and rational hot air recovery structure adopted as described above, external air inflow as well as hot air circulation by the air supply fan can be quickly and effectively induced and controlled by only two dampers; hot dry air can be applied even in a blowing operation at a high flow rate for drying the water-soluble paint, thereby improving convenience and economic effects of using the paint booth, increasing drying efficiency of different paints including oil-based paint and water-based paint, minimizing waste of energy due to a drying operation, and preventing dust scattering in the coating chamber to thus greatly contribute to improvement of working environment in the coating chamber as well as the coating quality.

Patent Literature 4 discloses a paint drying apparatus, comprising: a housing having a predetermined length and an internal space formed therein; a chain mounted to be movable from one end of the housing to the other end; a drive unit connected to one end of the chain to move the chain; a speed control unit to adjust a moving rate of the chain through the drive unit; a driven unit connected to the other end of the chain; and a hot air supply unit to supply hot air to an inner space of the housing, thereby facilitating maintenance and smooth operation of the device.

However, in the prior art described above, coating failure is still high, and other problems such as high energy consumption, a large amount of greenhouse gas occurring due to use of burner flame, a long time required for drying the paint, a long conveyor length, enlarged layout of paint equipment, etc., have to yet be overcome.

(Patent Document 1) KR10-0788503 B1

(Patent Document 2) KR10-2011-0123024A

(Patent Document 3) KR10-1320087 B1

(Patent Document 4) KR10-1481787 B1

### SUMMARY OF INVENTION

### Technical Problem to be Solved

The present disclosure has been proposed to overcome the aforementioned problems, and an object of the present invention is to provide a conveyor type paint drying furnace provided with an HSWG unit that can reduce coating failure and energy consumption by directly heating a dried surface, as an object to be dried, with heat by radiant waves, instead of using air in a drying chamber, in addition, that can allow rapid drying to reduce a layout of the drying furnace and provide a pleasant and clean working environment, as well as an HSWG unit for the above drying furnace.

### Technical Solution

In order to solve the above problems, according to an aspect of the present invention, there is provided a heat spreader and waveguide (HSWG) unit, including: a main body having a ceiling portion and a wall, wherein the ceiling portion and the wall are provided with waveguides; and one or more heat spreader modules in a space of the main body, wherein at least one among a waveguide extending downward from one lower side of the heat spreader module and an intermediate waveguide extending downward in a curtain shape is further included, and wherein each of the ceiling portion and the wall is formed in a unit length so that a plurality of units is combined to form a paint drying furnace.

In the HSWG unit of the present invention, the heat spreader module may include a housing opened downward and a radiant wave generator including a radiant wave converter and a heater provided in the housing, wherein the heater is provided in the radiant wave converter, and thermal energy from the heater is converted into radiant wave energy by a radiant wave conversion material applied to a surface of the radiant wave converter and then is emitted.

In the HSWG unit of the present invention, when the intermediate waveguide is provided, a plurality of holes is formed in an upper portion of the intermediate waveguide.

In the HSWG unit of the present invention, each of the radiant waveguides is manufactured by attaching a mica sheet or an aluminum foil to a base plate comprising a plate material, a fiber material or a nonwoven fabric.

The conveyor type paint drying furnace according to the present invention is formed by placing a trolley type conveyor, which suspends an object to be coated on an upper side thereof and transports the same, or a tray type conveyor, which stacks an object to be coated on a lower portion thereof and transports the same, in a paint drying furnace configured of a plurality of heat spreaders and waveguides successively connected together.

### Effect of Invention

Since the conveyor type paint drying furnace equipped with the HSWG unit of the present invention directly heats a coated surface using radiant waves without heating the air, coating failure is reduced and energy consumption and greenhouse gas generation are also reduced. Especially, temperature deviation in the drying furnace may be reduced to within ±5° C., so that high quality coating is secured.

Further, according to the conveyor type paint drying furnace equipped with the HSWG unit of the present invention, an energy density of radiant waves is high, thus decreasing or eliminating a fresh time for coating stabilization and a pre-drying setting time, whereby a drying time is shortened and a layout is reduced to less than half, while ensuring a pleasant and clean working environment.

Further, conventionally, when a worker touches the object after paint drying, scratches such as glove marks often occur and this problem is easily solved. Further, a problem of scratches occurring due to a wrapping paper, except when the coated object is wrapped with a high quality wrapping paper, can be overcome.

Further, according to the conveyor type paint drying furnace equipped with the HSWG unit of the present invention, exterior parts after completion of composite coating can be dried all together, whereby a development time or the entire process of coating exterior parts having new designs may be efficiently reduced.

Further, according to the conveyor type paint drying furnace equipped with the HSWG unit of the present invention, a smart drying furnace may be configured simply by replacing and disposing the HSWG unit in a typical hot air drying furnace, thereby reducing facility costs.

### BRIEF DESCRIPTION OF DRAWINGS

FIG. 1 is a conceptual cross-sectional view illustrating a first embodiment of the HSWG unit according to the present invention.

FIG. 2a is a conceptual cross-sectional view illustrating a heat spreader module part of the HSWG unit.

FIG. 2b illustrates a heater used in a heat spreader module.

FIG. 3 is a conceptual cross-sectional view illustrating a second embodiment of the HSWG unit according to the present invention.

FIG. 4 is a conceptual cross-sectional view illustrating a third embodiment of the HSWG unit according to the present invention.

FIG. 5 is a cross-sectional view conceptually showing a waveguide disposed inside the heat spreader module of the present invention.

### BEST MODE

The heat spreader and waveguide (HSWG) unit of the present invention may include: a main body having a ceiling portion and a wall, wherein the ceiling portion and the wall are provided with waveguides; and one or more heat spreader modules in a space of the main body, wherein at least one among a waveguide extending downward from one lower side of the heat spreader module and an intermediate waveguide extending downward in a curtain manner is further included, and wherein each of the ceiling portion and the wall is formed in a unit length so that a plurality of units is combined to form a paint drying furnace. Herein, the heat spreader module may include a housing opened downward and a radiant wave generator including a radiant wave converter and a heater provided in the housing, wherein the heater is provided inside the radiant wave converter, and thermal energy from the heater is converted into radiant wave energy by a radiant wave conversion material applied to a surface of the radiant wave converter and then is emitted.

### Detailed Description of Preferred Embodiments of Invention

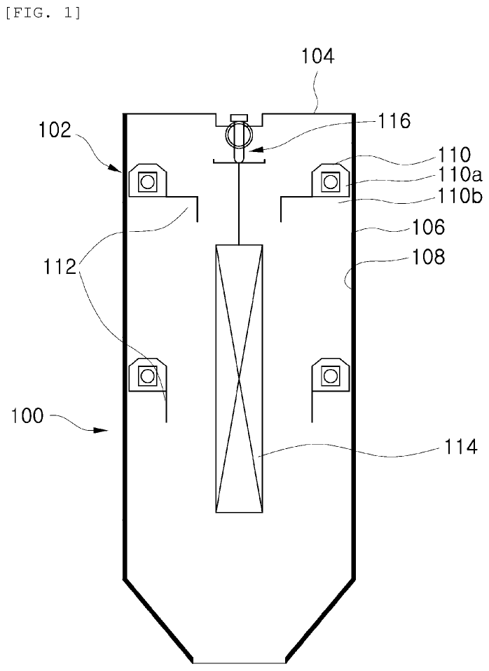

Hereinafter, a heat spreader and waveguide unit (“HSWG unit”) and a conveyor type paint drying furnace equipped with the HSWG unit according to the present invention will be described with reference to the accompanying drawings FIG. 1 is a conceptual cross-sectional view illustrating a first embodiment of the HSWG unit according to the present invention.

The HSWG unit 100 of the present invention includes a main body 102 wherein the main body 102 has a ceiling portion 104 and a wall 106. The walls 106 on both sides may extend from each other to form a bottom portion. The ceiling portion 104 and the wall 106 are provided with a waveguide 108 on the inner surface thereof.

One or more heat spreader modules 110 are provided in a space of the main body 102 and another waveguide 112 extending downward from one lower side of the heat spreader module 110 is included. The extended waveguide 112 may form a further radiant wave conversion chamber at the bottom of the heat spreader module 110, thereby improving radiant wave generation efficiency. That is, a radiant wave conversion chamber 110a to convert thermal energy into radiant wave energy in the heat spreader module 110 is provided to convert high temperature thermal energy into radiant wave energy, and the extended waveguide 112 may form an additional radiant wave conversion chamber 110b to maintain a higher temperature in the radiant wave conversion chamber 110a, thereby improving radiant wave conversion efficiency. Generally, a waveguide allows an object to be efficiently irradiated and dried with far infrared rays. That is, the waveguides 108 and 112 herein may guide radiant wave energy of the far-infrared rays converted by the heat spreader module 110 to the object to be dried in the drying furnace without escaping from the drying furnace, and may function to evenly distribute the radiant wave energy. Further, each of the waveguides 108 and 112 is made of a known material reflecting far-infrared rays, for example, the waveguide may be formed by attaching an aluminum foil or a mica sheet to a base plate comprising a plate material, a fiber material or a nonwoven fabric. Herein, a shape or material of the waveguide may be diversely adopted.

The ceiling portion 104 and the wall 106 of the HSWG unit 100 are formed in a unit length of, for example, about 1 to 1.5 m, and a plurality of units is combined to form a paint drying furnace. For example, a drying furnace having a length of 50 to 70 m may be formed by joining 50 HSWG units in succession. The unit length may be increased or decreased as needed. In addition, width and height of the HSWG unit may also be appropriately determined in consideration of a size and coating characteristics of the object to be dried. A conventional hot-air drying furnace may be remodeled using the HSWG unit 100 so as to rapidly and easily fabricate a smart drying furnace. Further, using the HSWG unit 100 of the present invention may reduce a length of the conventional hot air type drying furnace to at least half the original length.

A plurality of HSWG units may be connected to constitute a drying furnace, which in turn may be provided with a trolley type conveyor 116 to suspend and transport the object 114 to be dried in the drying furnace. Far infrared rays are radiated from the heat spreader module 110 in each HSWG unit 100 to dry a surface of the object 114 while transferring the object 114 by the trolley type conveyor 116.

FIG. 1 illustrates a state wherein four heat spreader modules 110 are arranged in one HSWG unit. The number of heat spreader modules 110 in one HSWG unit depends on heating, drying and hardening temperatures of various paints, or a size of the object to be dried.

Within the drying furnace having such a structure as described above, a surface temperature of the object to be dried may be adjusted usually in a range of 80 to 230° C., and the temperature is appropriately selected depending on the size of the object to be dried and the coating properties thereof.

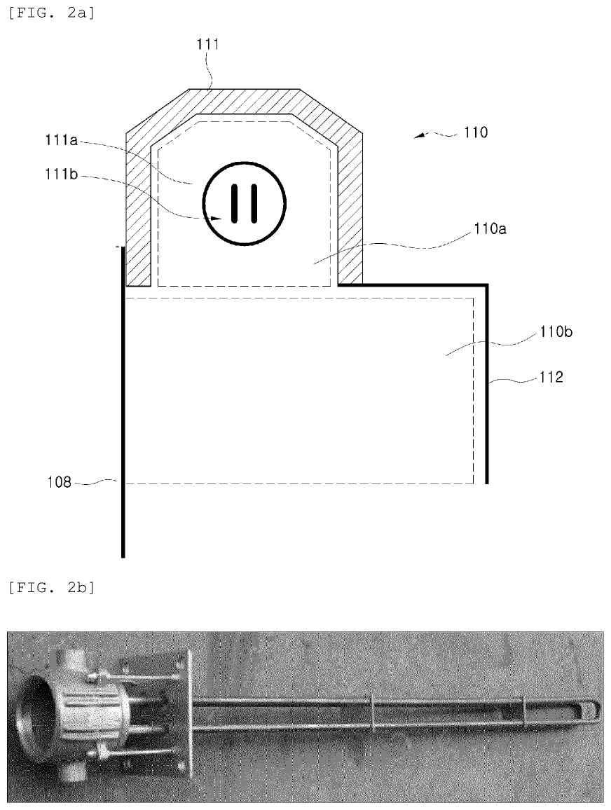

FIG. 2a is a conceptual cross-sectional view illustrating the heat spreader module portion 110 of the HSWG unit.

The housing 111 of the heat spreader module 110 opened downward is made of a heat insulating material and an inner surface of the housing 111 is made of the same material as the waveguide. The inner space of the housing 111 forms a radiant wave conversion chamber 110a. A waveguide 112 extending downward from one lower side of the housing 111 is provided, and may form a second radiant wave conversion chamber 110b on the bottom of the housing 111 along with the waveguide 108 at the wall 106 of the HSWG unit 100. The extended waveguide 112 may prevent heat loss due to convection to maintain a temperature of the radiant wave conversion chamber 110a at a high temperature close to, for example, about 450° C. and may convert thermal energy into high density radiant wave energy, thereby increasing conversion efficiency of the radiant wave energy. In other words, the extended waveguide may allow emission of high density radiant wave energy to increase a drying speed. Further, the waveguides may enable radiant wave energy to be distributed and evenly radiated without being directly concentrated on the object 114 to be dried, thus attaining effects of reducing temperature deviation on the surface of the object 114.

The first radiant wave conversion chamber 110a is provided with a radiant wave generator including a radiant wave converter 111a and a heater 111b. The heater 111b is disposed inside the radiant wave converter 111a. Thermal energy from the heater 111b may be converted into radiant wave energy by a radiant wave conversion material applied to a surface of the radiant wave converter 111a and then emitted. The heater 111b used herein may be an electrical pipe heater commercially available in the art.

Since thermal energy is converted into radiant wave energy and then emitted, the object 114 to be dried may be directly heated and dried without heating air around the object 114, thereby remarkably improving thermal efficiency and a quality of the coated surface.

FIG. 2b illustrates the heater 111b used in the heat spreader module 110. The heater 111b used herein may be an electrothermal heater. The heater 111b is usually mounted in the radiant wave converter 111a in a pipe shape.

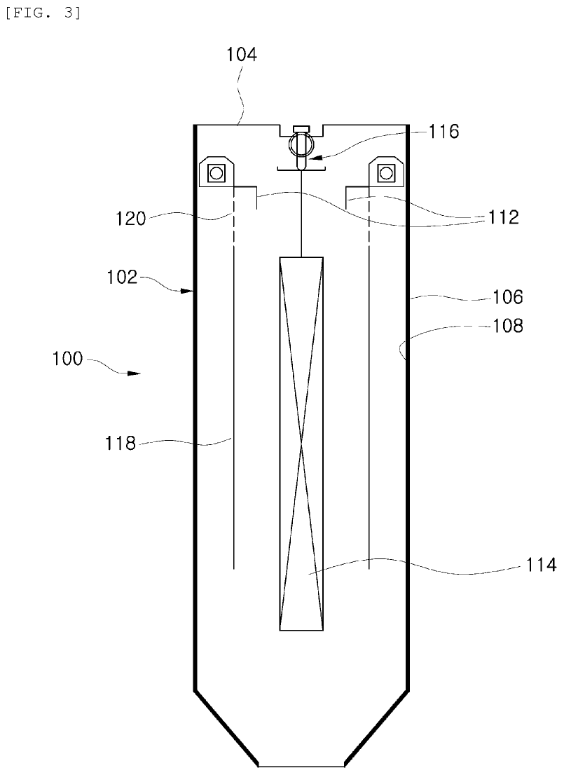

FIG. 3 is a conceptual cross-sectional view illustrating a second embodiment of the HSWG unit according to the present invention.

As in the first embodiment, the HSWG unit 100 of the second embodiment may include a main body 102 having a ceiling portion 104 and a wall 106. Similarly, the ceiling portion 104 and the wall 106 are also provided with a waveguide 108 on an inner surface thereof.

Further, one or more heat spreader modules 110 may be provided on upper portions at both sides in a space of the main body 102. The heat spreader module 110 includes a waveguide 112 extending downward from one lower side thereof. The heat spreader module 110 may further be provided with an intermediate waveguide 118 which extends downward from the heat spreader module 110 to evenly distribute radiant wave energy without being concentrated. Either the extended waveguide 112 or the intermediate waveguide 118 may be included or, otherwise, both the extended waveguide 112 and the intermediate waveguide 118 may be provided.

The intermediate waveguide 118 extends downward from the heat spreader module 110, thus extending downward over at least a portion of the object 114 to be dried. The intermediate waveguide 118 prevents radiant wave energy generated in the heat spreader module 110 from directly and intensively irradiating the object 114 to be dried, thereby evenly emitting and distributing the radiant wave energy.

A plurality of holes 120 is formed in an upper portion of the intermediate waveguide 118. These holes 120 allow radiant wave energy to be evenly distributed and radiated to the object 114 to be dried.

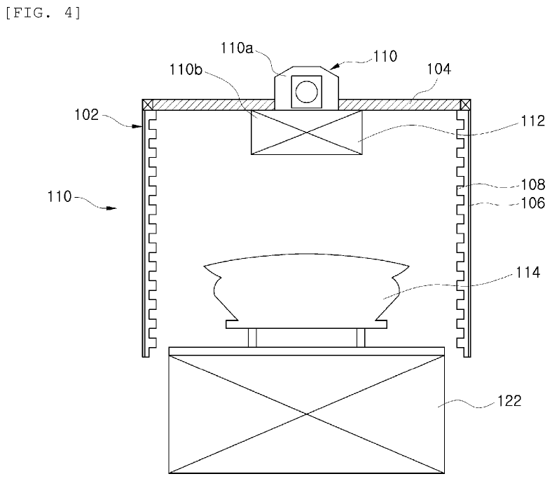

FIG. 4 is a conceptual cross-sectional view illustrating a third embodiment of the HSWG unit according to the present invention.

The HSWG unit 100 of the present invention includes a main body 102, and the main body 102 has a ceiling portion 104 and a wall 106. The ceiling portion 104 and the wall 106 are provided with a waveguide 108 on an inner surface thereof.

One or more heat spreader modules 110 may be provided on the ceiling portion 114. The heat spreader module 110 includes a waveguide 112 extending downward from one lower side thereof. The extended waveguide 112 may be provided with an additional radiant wave conversion chamber on the bottom of the heat spreader module 110, thereby further improving radiant wave generation efficiency. In other words, the heat spreader module 110 may be provided with the radiant wave conversion chamber 110a to convert thermal energy into radiant wave energy, thereby converting thermal energy at a high temperature into radiant wave energy. Further, the extended waveguide 112 may be provided with an additional radiant wave conversion chamber 110b to maintain a higher temperature inside the above radiant wave conversion chamber 110a, thereby improving radiant wave conversion efficiency. In addition, the extended waveguide 112 may evenly distribute and emit the radiant wave energy generated in the heat spreader module 110 over the object 114 to be dried. The waveguide 108 provided on an inner surface of the wall 106 may be a waveguide 108 shown in FIG. 1, a protruding waveguide or a shutter-type waveguide with adjustable height. The object 114 to be dried may be successively transferred by a tray type conveyor 108 on which the object 114 can be placed. The successively transferred object 114 may be substantially evenly irradiated and dried with radiant wave energy generated from each of the heat spreader modules 110 in HSWG units 100 arranged in succession.

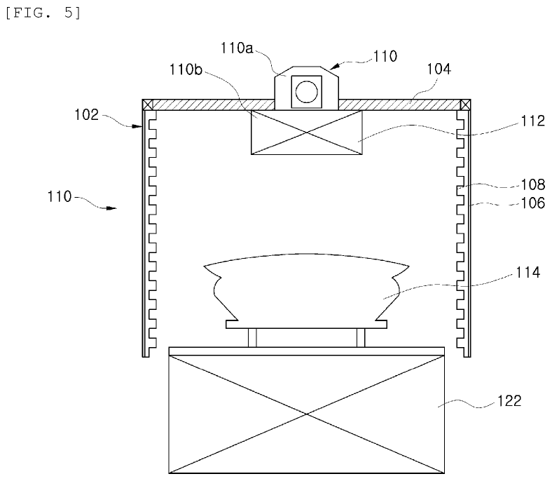

FIG. 5 is a cross-sectional view conceptually illustrating waveguides disposed inside the heat spreader module of the present invention.

A plurality of inclined waveguides 124 may further be disposed inside the radiant wave conversion chamber 110b formed by the extended waveguide 112 under the heat spreader module 110. The inclined waveguide 124 is provided for more evenly distributing and emitting the radiant wave energy generated in the heat spreader module 110 in a longitudinal direction of the drying furnace.

The conveyor type paint drying furnace equipped with the HSWG unit of to the present invention may be configured in various forms according to a size of an object to be coated, heating conditions, and the like. In other words, the drying furnace of the present invention may be configured in diverse forms such as: a small trolley type paint drying furnace having a tunnel height of less than 3 m, which is optimized for drying an object coated by painting, powder coating and water-soluble liquid coating after plating at a relatively high temperature of 150 to 230° C.; a medium size trolley type paint drying furnace having a tunnel height of 3 to 5 m, which is optimized for drying an object coated by oil liquid coating at a relatively low temperature of 80° C.; or a tray conveyor type paint drying furnace, which is optimized for completely hardening an object to be coated such as automobile exterior parts by heating, drying and melting the object at a temperature in a wide range of 80 to 230° C. Further, it is possible to simply replace a conventional hot air drying furnace with the drying furnace equipped with HSWG units according to the present invention. While the present invention has been particularly illustrated and described with reference to exemplary embodiments thereof, it is to be understood that the invention is not limited to the configurations and functional effects of the disclosed exemplary embodiments. On the contrary, it will be understood by those skilled in the art that numerous alterations and modifications of the invention are possible without departing from the spirit and scope of the invention. Therefore, all such modifications, alterations and equivalents are to be regarded as being within the scope of the present invention.

### INDUSTRIAL APPLICABILITY

The conveyor type paint drying furnace equipped with the HSWG unit according to the present invention is capable of rapidly drying a composite paint sample. Therefore, it is anticipated that parts suppliers may develop exterior parts coated with new designs and provide samples of the parts to any global automobile company or household appliance company, thereby successfully receiving orders for the samples. Consequently, it will be expected to increase international competitive power of parts suppliers and painting companies. Further, it is possible to re-model an existing hot air convection type drying apparatus into one similar to the conveyor type paint drying furnace of the present invention only by applying the HSWG unit to the existing drying apparatus, thereby reducing energy required for paint drying as well as greenhouse gas emissions. Further, it is possible to reduce coating failure by offering a smart paint drying furnace.

In addition, the inventive drying furnace may be helpful to parts suppliers and painting companies as subcontractors of automobile exterior parts in quickly and easily developing new designs for external parts. Accordingly, when samples of newly developed products are presented to global automobile manufacturers for order receipt, the order may be easily received, which in turn assists the parts suppliers and painting companies to evolve into specialized color design exterior companies for automobile parts.

1. A heat spreader and waveguide (“HSWG”) unit, comprising:
a main body 102 having a ceiling portion 104 and a wall 106, wherein the ceiling portion 104 and the wall 106 are provided with waveguides 108; and
one or more heat spreader modules 110 in a space of the main body 102,
wherein at least one among a waveguide 112 extending downward from one lower side of the heat spreader module 110 and an intermediate waveguide 118 extending downward in a curtain manner is further included, and
wherein each of the ceiling portion 104 and the wall 106 is formed in a unit length so that a plurality of units is combined to form a paint drying furnace.

2. The unit according to claim 1, wherein the heat spreader module 110 includes a housing 111 opened downward, and a radiant wave generator including a radiant wave converter 111a and a heater 111b is provided in the housing 111,
wherein the heater 111b is provided in the radiant wave converter 111a so that thermal energy from the heater 111b is converted into radiant wave energy by a radiant wave conversion material applied to a surface of the radiant wave converter 111a and then is emitted.

3. The unit according to claim 1, wherein, if the intermediate waveguide 118 is provided, a plurality of holes 120 is formed in an upper portion of the intermediate waveguide 118.

4. The unit according to any one of claims 1 to 3, wherein each radiant waveguide is formed by attaching an aluminum foil or a mica sheet to a base plate including a plate material, a fiber material or a nonwoven fabric.

5. A conveyor type paint drying furnace formed by combining a plurality of HSWG units 100 according to claim 1 in succession, comprising:
a trolley type conveyor 116, which suspends an object to be coated on an upper side thereof and transports the same; and/or a tray type conveyor 122, which stacks an object to be coated on a lower portion thereof and transports the same, is provided.
